(19) United States
(12) Patent Application Publication
(10) Pub. No.: US 2008/0098601 A1
(43) Pub. Date: May 1, 2008

(54) TUBULAR TAPERED CRUSHABLE STRUCTURES AND MANUFACTURING METHODS

(75) Inventors: Richard D. Heinz, Grand Haven, MI (US); Bruce W. Lyons, Grand Haven, MI (US); Guy M. Ignafol, Muskegon, MI (US); David W. Heatheringon, Spring Lake, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Shape Corporation

(21) Appl. No.: 11/766,406

(22) Filed: Jun. 21, 2007

Related U.S. Application Data
(60) Provisional application No. 60/863,488, filed on Oct. 30, 2006.

(51) Int. Cl. B21D 53/88; B60R 19/18

(52) U.S. Cl. 29/897.2; 296/187.03

(57) ABSTRACT

A method includes steps of providing round tubing, providing a compression box and wedging dies, and reshaping the round tubing into a single or double-tapered rectangular tube including using the compression box to control an outside shape, while using the wedging dies to force material of the tubing outwardly toward the compression box. This arrangement minimizes material thinning. A tubular crushable structure is produced that is designed for longitudinal impact-energy-absorbing capability. The crushable structure includes a single or double-tapered rectangular tube made of material having a tensile strength of at least 40 KSI. In a narrower form the tensile strength is at least 80 KSI, though it can be 100 KSI or higher.

This application claims benefit under 35 U.S.C. § 119(e) of provisional application Ser. No. 60/863,488, filed Oct. 30, 2006, entitled TUBULAR TAPERED CRUSHABLE STRUCTURES AND MANUFACTURING METHODS.

### BACKGROUND

The present invention relates to crushable structures configured for energy absorption and energy management such as during a vehicle crash.

Vehicle components are designed to reduce property damage and provide safety to the occupants of an impacted vehicle through energy management. This is typically accomplished by designing vehicle components for predictable and repeatable deformation. In low-speed impacts, components such as bumpers and bumper brackets are designed to absorb significant amounts of energy when impacted via deformation of these components. For higher-speed impacts, the vehicle chassis is designed to absorb energy by deforming. Side impacts also use deformable components such as sills, rocker panels, pillars and door impact beams. One main difference between the side impact components and those components located on the front or the rear of the vehicle is in how they are designed to absorb energy via deformation. The side impact components absorb energy via deformation associated with side-bending-type shape change of the components. Frontal and rear components such as bumper brackets and chassis components are designed to crush in an accordion fashion in a direction parallel to the impacting force. In frontal and rear impacts, the collision is either between a moving vehicle and a fixed object (wall, barrier, pole, tree, etc.) or between two moving vehicles. The impact energies are typically high due to speeds and crash dynamics. Chassis components must be able to deform in a predictable and repeatable manner to provide safety to the occupants and reduce property damage.

Different types of component failure will produce different response curves and varying degrees of efficiency in terms of how the energy is absorbed. Impact energy absorption is calculated by multiplying a force of impact resistance times the impact stroke of a component. A component having a high efficiency of energy absorption is generally described as a component that absorbs a desired maximum amount of energy continuously over a desired maximum stroke distance. A tubular structure that bends over when impacted in a near axial direction has absorbed energy, but has not done so in a very efficient manner. A more efficient response would be had if the tube folded on itself in an accordion fashion. The accordion-type deformation provides the greatest amount of energy absorption within the provided package space. The final deformed piece represents the smallest packaging space of stacked material. The described innovation defined in this write-up is a crushable tubular structure that when impacted in a near axial direction, will collapse on itself in an accordion fashion. This innovative design can be scaled for small applications such as a bumper bracket or for larger applications such as a chassis component.

The use of tubular structures for both chassis components and/or bumper brackets is nothing new. These types of tubular structures have been used on many various components throughout the vehicle. Most applications with this type of tubular structures coincide with protection from axial and near axial impacts. There are various manufacturing processes that are capable of producing tubular structures that when impacted in a near axial direction, will collapse on itself in an accordion fashion. The complexity and inherent cost associated with the manufacturing processes tend to increase as the energy management efficiency of the design increases. Manufacturing processes capable of producing tubular structural components and ranked by cost from high to low include hydroformed, clamshell designs fabricated from two stampings spot-welded together, deep-drawn stamping, simple expansion using internal mandrels, and simple rollformed tubular designs with crush initiators.

Tubular components can be formed by hydroforming processes into complex shapes having non-uniform cross sections that vary along their length, where the non-uniform cross sections are tailored for particular needs and properties, such as for energy absorption. For example, vehicle frames often include hydroformed components. However, hydroforming processes are expensive, messy (since they involve placing a fluid within a tube and then pressurizing the fluid), and tend to require relatively long cycle times. Further, they become generally not satisfactory when higher strength materials are used, such as High-Strength-Low-Alloy (HSLA) materials, and/or Advanced-Ultra-High-Strength Steel (AUHSS) materials, since these materials are difficult to form, have low stretchability and poor formability, and tend to wear out tooling quickly.

It is desirable to provide a crushable structure that can be made from high-strength steels, yet with reasonable cost and that will crush during an impact with excellent repeatable and predictable results. Thus, a component, and apparatus and method of manufacturing same having the aforementioned advantages and solving the aforementioned problems is desired.

### SUMMARY OF THE PRESENT INVENTION

In one aspect of the present invention, a method of forming an axially crushable structure suitable for energy absorption during an axial impact includes providing a section of tubing, providing a compression box and wedging dies, and positioning the tubing in the compression box and positioning the wedging dies at least partially in the tubing. At least a portion of the tubing is reshaped into a tapered polygonal tubular shape with a non-circular cross section, including using the compression box to control an outside shape while using the wedging dies to force material of the tubing outwardly into engagement with the compression box.

In another aspect of the present invention, a tubular crushable structure is designed for longitudinal impact-energy-absorbing capability. The crushable structure includes a polygonal tube having a tapered portion and a second non-tapered portion aligned with the tapered portion. The tube is made of material having a tensile strength of at least 40 KSI and having a substantially constant wall thickness along its entire length.

In another aspect of the present invention, a tubular crushable structure is designed for longitudinal impact-energy-absorbing capability. The crushable structure includes a polygonal tube having a tapered polygonal portion and a non-tapered polygonal portion and having a substantially constant wall thickness along its entire length.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a raw tubing component with constant section and a finished tubular double-tapered rectangular tube component useful as a bumper crush tower.

FIG. 2 is a perspective view of a tapered die for forming the raw tubing component.

FIG. 3 is a perspective view of a straight section guide tube for use with the tapered die.

FIG. 4 is a perspective view of a push collar for pushing the round tubing component into the tapered die.

FIGS. 5a and 5b are perspective views of a double tapered round tube formed from the raw tubing component, and a double-tapered rectangular tube component made from the tube of FIG. 5a; and FIGS. 5c and 5d are end views of FIGS. 51 and 5b.

FIG. 6 is a perspective view of a mandrel set, and FIGS. 6a and 6b are perspective views of the outer mandrels and inner mandrel, respectively.

FIG. 7 is a perspective view of a compression box usable with the mandrels of FIGS. 6a and 6b for the double-tapered rectangular tube component of FIG. 5b.

FIG. 8 is a perspective view of the finished double-tapered rectangular part with crush initiators.

### DETAILED DESCRIPTION OF PREFERRED EMBODIMENTS

The present concept combines standard low-cost manufacturing processes to produce a tube of high strength material which, upon near axial impact, produces a lower-weight part having a force/deflection response similar to that produced by the more expensive hydroformed process. The proposed inventive concepts are based on the ability to reform round tubing into a double-tapered rectangular component. Crush initiators are strategically imparted to the double-tapered rectangular component during the manufacturing process. The write-up contained here within will concentrate on the double-taper rectangular design, but it should be noted that the concept and manufacturing process can be used on any sided polygonal-shaped tubular component. It should become obvious to anyone skilled in the trades that the manufacturing processes defined within this write-up overcomes common material limitation associated with reforming a straight constant geometry shape into a double-tapered geometry of a different shape.

The proposed inventive concepts take advantage of the benefits of and overcome the formability limitations associated with the higher physical properties of such materials as structural steel, High-Strength-Low-Alloy (HSLA) steel and Advanced Ultra-High-Strength Steel (AUHSS). In the present text, when we refer to various steels, we define structural steel as material having a tensile strength of at least about 40 KSI or higher, High-Strength-Low-Alloy (HSLA) steel as material having a tensile strength of at least about 80 KSI or higher, and Advanced Ultra-High-Strength Steel (AUHSS) as material having a tensile strength of at least about 100 KSI or higher. The higher physical properties associated with these materials provide greater energy absorption during deformation and allow for down-gauging of thickness to achieve similar performance to thicker gauge lower grade materials. The ability to down-gauge thickness and maintain performance represents a reduction in part cost and potentially a reduction in piece price. A significant drawback to using materials with higher physical properties is that materials with higher physical properties also have reduced formability as the physical properties get higher. As the yield and tensile strength increase, the elongation and in turn the formability of the material decrease. The presented inventive concepts overcome the formability limitation associated with using higher physical property materials and provide the opportunity to reduce material gauge to achieve similar performance to more formable materials.

The following process will describe the steps necessary to overcome formability issues associated with using higher grade materials and to produce a double-tapered rectangular shaped tube from a reshaped round tube. By the term “double-tapered,” we mean a tube with a first tapered portion and a different second portion (which can be tapered or non-tapered). For illustration purposes, a round Drawn-Over Mandrel (DOM) commercially available tube will be reformed to create a double-tapered rectangular tube. The DOM tube has higher physical properties than those associated with an Electrically Resistance Welded (ERW) tube due to the additional work hardening associated with the DOM process. The DOM material used for this example had the following physical properties; Yield Strength=67,021 psi, Tensile Strength=83,775 psi, and a 0.2% Elongation=12.65%. DOM tubing with an outside diameter of 4.75 inches was used and the length of the tubing was approximately 24 inches. These physical properties are in line with structural steels and HSLA steels.

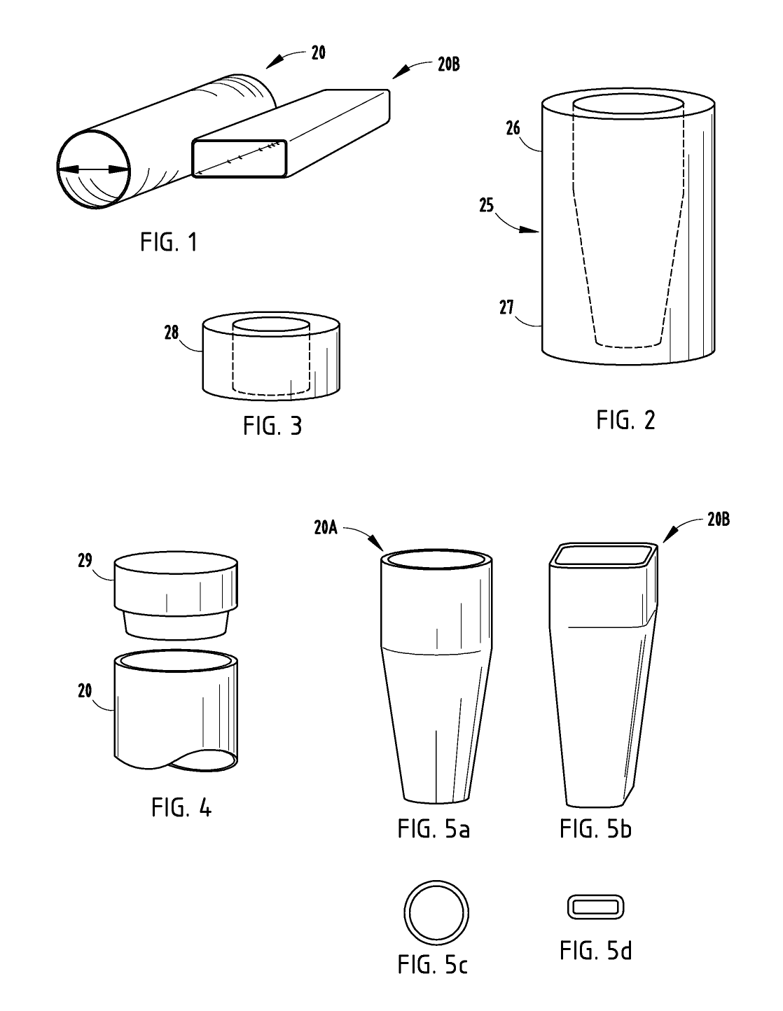

In the original round tubular component 20 (also called “round tubing” herein) (FIG. 1), the outside diameter of the DOM tubing was sized such that the circumference of the tube is slightly undersized when compared to the perimeter of the large end of the partially finished double-tapered rectangular tube 20B. The partially finished double-tapered rectangular tube 20B has a double-tapered rectangular shape, including a first rectangular portion with a first taper (or no taper), and a second rectangular portion with a different second taper. (See FIG. 1.) Sizing of the circular tube outside diameter in this way will allow for some minor expansion to achieve the required perimeter of the large end of the double-tapered rectangular. The reforming and expansion process will be defined in detail in later paragraphs. The amount of expansion to go from round to rectangular should be kept to a minimum to reduce the stress on the material. Keeping expansion to a minimum is important considering the reduced formability of the higher grade of materials that are desirable for these types of deformable energy management components.

The round DOM tubing 20 is forced into a tapered die 25 (FIG. 2). The die is made from hardened steel and can be produced on a lathe. The die 25 is made in sections 26 and 27 to provide ease of handling and also to provide flexibility in changing taper angle and taper depth. A straight section 28 of the die 25 can be used to guide and support the round tubing 20 into the tapered end of the main die 25 if there are concerns associated with column bucking of the round tubing 20 as it is forced into the tapered main die 25 (FIG. 3). For this particular example, a straight section 28 to guide and support the round tubing 20 was not necessary and hence was not used for the DOM tubing.

A special push collar 29 (FIG. 4) was developed that fit inside the round tubing 20 to transfer push loads to the outside edge of the tubing 20 as the tubing 20 was forced into the tapered die 25. The round tube 20 was forced into the tapered die 25 (FIG. 2) through a distance that coincided to its desired length. At the end point of insertion into the die 25, the circumference of the smaller tapered end of partially-finished round tube 20A was slightly undersized when compared to the final perimeter of the small end of the tapered rectangular shape in the finished part 21 (FIG. 5). The now tapered round tube 20A is removed from the die 25 by applying an upward force to the tapered end, forcing the tube 20A in a reverse direction back through the top of the die 25. It is noted that the described die 25 used to taper the round tube 20A is a piece of prototype tooling and a different die configuration might be more suitable for high volume production.

The tapering process may cause a length of the original tubes 20 to grow a small amount depending on the amount of the taper. Notably, a perimeter change causes material in these hard-to-form materials to move primarily in a length direction of the tube 20. In the case of this example, the tube 20A grew approximately 0.25 inches. The amount of length growth for the tube 20A is dependent on the material type, material thickness and the amount of taper that is imparted on the raw tube 20. There can be a slight increase in the thickness of the round tube 20A, however this thickness change is not considered significant. If there is some thickness increase, the increase of thickness is most evident at the end of the round tube that experiences the greatest amount of taper. (See FIG. 5, diameter “a.”) Elongation of the round tube 20A during tapering actually minimizes the amount of thickness change at the point where the maximum taper occurs on the tube.

For the example presented here, material thickness at the tapered end increased only by approximately 0.009 inches. This compares to an average material thickness in the present example of about 0.132 inches, such that the thickness change is less than 7%. It should also be noted that for the materials proposed for this concept, the variation in material thickness for as received coil stock in the present example is typically +/−0.005 inches, or about 4%. Therefore, a material thickness change of only 7% was not considered significant in the present example. For the present discussion, a material thickness change of about 7% or less along a length of a tube is considered to be a substantially constant wall thickness along the entire length of the tapered tube.

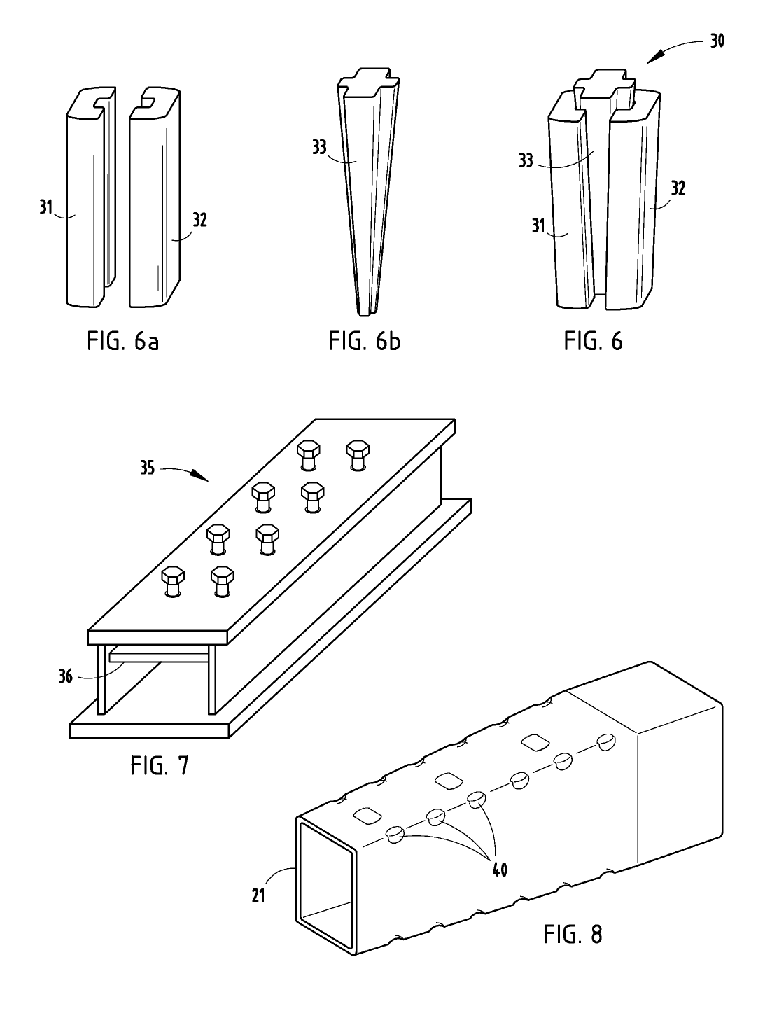

The tapered round tube 20A is now ready for reshaping. The tapered round tube 20A is now ready to be reshaped to a double-tapered rectangle 20B. The reshaping process is accomplished with a combination of pure reshaping and some minor expansion. Expansion will be kept to a minimum to maintain the integrity of the wall thickness of the tube. A three-piece mandrel 30 was used to reshape the round tube 20A (FIG. 6). The outer two pieces 31 and 32 of the mandrel 30 are shaped to represent the shorter sides of the rectangle (FIG. 6a). These mandrels 31 and 32 include the corner radii of the finished rectangular shape. The third part 33 of the mandrel 30 is the center section (FIG. 6b). The two mandrels 31 and 32 are keyed and fit together with the center section 33 of the mandrel 30. The center section 33 of the mandrel 30 is tapered, so as the center section 33 is moved down between the two mandrels 31 and 32, the mandrels 31 and 32 spread apart to create a tapered rectangular mandrel 30. FIG. 6 shows a constant angle taper to the center section 33, but in actuality the center section 33 and/or mandrels 31 and 32 can be made of sections that are tapered and/or sections that are non-tapered.

The three-piece mandrel 30 often can not be used by itself to reshape the tapered round tube 20A to a double-tapered rectangular because of forming limitations of the desired materials. The mandrel action required to change shape from round to rectangular potentially results in significant material thinning just off the radii of the rectangular final part. The thinning may happen when the reshaping method does not allow the material to flow from one shape to another. To reshape using the internal mandrels and at the same time minimize thinning of the material, an additional fixture is desirable. A compression box 35 (FIG. 7) was developed to help the material flow during the reshaping operation that uses the internal three piece mandrels 31-33. The compression box 35 is a tapered box where three sides of the box represent the finished shape of the double-tapered rectangle. The three finished sides are the two short sides of the rectangle and one of the long sides. The compression box 35 does not mimic the radii of the finished shape but instead only mimics the overall position of the walls of the tapered rectangle. The non-fixed face 36 of the compression box 35 is also one of the longer sides of the rectangle. This non-fixed face 36 of the compression box 35 is adjusted inward and against the tapered round tube 20A while the mandrels 31-33 are forced down the length of the tapered round tube 20A. The ability to adjust the non-fixed face 36 of the compression box 35 assists in the movement of material in a way that facilitates reshaping the round shape of the tube 20A to a rectangular shape of the finished part 21 without thinning and undesirable weakening.

The compression box 35 reduces the amount of expansion that is required to reshape the part and in turn reduces the amount of material thinning. The desire to perform a reduced amount of expansion is necessary to help size the ends of the tapered rectangle and at the same time force the repeatability of end geometries. It is noted that the detailed design of illustrated compression box 35 illustrates only one adjustable movable surface. However, it is contemplated and envisioned that multiple sides of the compression box 35 can be made to move or adjust. It is contemplated that those skilled in the art will understand how to do so once they understand the present concept. The use of multiple moving surfaces of the compression box 35 would assist in the movement of material and this may be required on the reshaping of more complex polygonal shapes. The additional movable surfaces might also be necessary to increase tolerances on geometric sizing of the finished shape's surfaces and ends.

In a production mode, it is envisioned that the compression box 35 can be adjusted with hydraulics, pneumatics, and/or servos. It is envisioned that adjustment of the non-fixed face 36 of the compression box 35 can be adjusted in synchronization with the position of the mandrels 31-32 as they move down the length of the round tube. This type of control would be based a closed loop control system where the location of one aspect of the process is used to control another aspect of the process.

The tapered shape of the rectangle in the finished part 21 helps to promote an accordion style of collapse when the tube is impacted in a near axial direction. The repeatability of this type of crush is questionable due to slight variations in the load direction and the location of deformation along the length of the tube. To improve the repeatability of the crushing action, crush initiators 40 (FIG. 8) are typically added to the crushable parts. The type, placement, and number of crush initiators 40 required usually will require a development effort to identify the most optimized design. The crush initiators 40 can be added to the part preferably after the final shape has been formed. For this example, the crush initiators 40 would be added to the double-tapered rectangular shape.

In a production mode, the crush initiators 40 can be added using any type of stamping method, hydraulic, pneumatic, etc. Internal support will more than likely be required when the crush initiators 40 are stamped into the part. It is envisioned that the crush initiators 40 can be added to the part when the internal reshaping mandrels are positioned in the part. The internal outer mandrels 31, 32 would need relief at each of the locations where the initiators 40 are to be placed. The central mandrel 33 could be backed out of the part which would allow the two outside mandrels 31, 32 to come free from the just-stamped-in crush initiators 40. In a walking-beam-type production process, the crush initiators 40 could be added to the part in a stand-alone station. It should also be noted that holes, slots, etc. . . . have been commonly used in the past as crush initiators. The manufacturing process associated with adding holes or slots is similar to the dart type of crush initiator. Both types of crush initiators will require some type of support within the tube, i.e., mandrel, die steels, etc.

The advantages of the present inventive concept include at least the following. The part can be double-tapered, which is a type of design that has proven itself to be very robust for collapsing in an accordion fashion when loaded in a near axial direction. The manufacturing “build” concept does not require a high degree of formability in the material, which allows for the use of higher grade steels. The present inventive concept expands acceptable raw steels that will work for this application, including structural steels (with tensile strength of at least 40 KSI), High-Strength-Low-Alloy (HSLA) steels (with tensile strength of at least 80 KSI) and Advanced-Ultra-High-Strength Steels (AUHSS) (with tensile strength of at least 100 KSI or more). These acceptable material grades are considerably higher than those that are acceptable for other manufacturing processes such as hydroforming and expansion. The manufacturing steps required are not unique but instead the uniqueness of this concept lies in how these manufacturing processes are combined to produce the end product. Proper material selection can result in a lighter-weight part through down-gauging material thickness and taking advantage of the higher grade materials. This can also result in a reduction of piece price.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A method of forming an axially crushable structure suitable for energy absorption during an axial impact, comprising steps of:
providing a section of tubing;
providing a compression box and wedging dies;
positioning the tubing in the compression box and the wedging dies at least partially in the tubing; and
reshaping at least a portion of the tubing into a tapered polygonal tubular shape with a non-circular cross section, including using the compression box to control an outside shape while using the wedging dies to force material of the tubing outwardly into engagement with the compression box.

2. The method defined in claim 1, wherein the wedging dies include cooperating mandrels and a center section that, when moved axially, causes the cooperating mandrels to move apart toward the inner surfaces of the compression box.

3. The method defined in claim 2, wherein the inner surfaces of the compression box and the cooperating mandrels include structure forming crush initiators into walls of the tubing.

4. The method defined in claim 3, wherein the tubing is made from a material having a tensile strength of at least about 40 KSI.

5. The method defined in claim 4, wherein the tubing is made from a material having a tensile strength of at least about 80 KSI.

6. The method defined in claim 5, wherein the tubing is made from a material having a tensile strength of at least about 100 KSI.

7. The method defined in claim 2, wherein at least one of the inner surfaces of the compression box is adjustable to define a different shape.

8. The method defined in claim 1, wherein the tubing has a round cross section, and including a step of forming the round tubing into a first polygonal shape prior to the step of reshaping.

9. The method defined in claim 1, including forming crush initiators into the tapered polygonal tubular shape to form a finished tubular polygonal crushable structure.

10. The method defined in claim 1, wherein the step of reshaping includes forming a first portion of a length of the tubing into a tapered polygonal shape and forming a second portion of the length of the tubing into a non-tapered polygonal shape.

11. The method defined in claim 1, wherein the step of reshaping includes forming a rectangular cross section in the tubing.

12. The method defined in claim 1, wherein the step of providing tubing includes making the round tubing of material having a tensile strength of at least about 40 KSI.

13. The method defined in claim 1, wherein the step of reshaping includes maintaining a thickness of material along the tubing to less than 10% variation in material thickness.

14. The method defined in claim 13, wherein the step of reshaping includes maintaining a thickness of material along the tubing to less than about 7% variation in material thickness.

15. The method defined in claim 1, wherein the step of reshaping includes moving material primarily in a length direction of the tubing and not in a circumferential direction of the round tube.

16. A tubular crushable structure designed for longitudinal impact-energy-absorbing capability comprising:
a polygonal tube having a tapered portion and a second non-tapered portion aligned with the tapered portion, the tube being made of a single sheet of material having a tensile strength of at least 40 KSI and having a substantially constant wall thickness along its entire length.

17. The structure defined in claim 16, wherein the wall thickness has less than 10% variation in thickness along its length.

18. The structure defined in claim 16, wherein the material has a tensile strength of at least 40 KSI.

19. The structure defined in claim 18, wherein the material has a tensile strength of at least 80 KSI.

20. The structure defined in claim 16, wherein the second portion has a circumference at least as large as the tapered portion.
